(19) United States
(12) Patent Application Publication
(10) Pub. No.: US 2026/0178367 A1
(43) Pub. Date: Jun. 25, 2026

(54) MULTIPLE NODE SERVERS HAVING DISTRIBUTED MANAGEMENT APPLICATION OPERATING ENVIRONMENTS

(71) Applicant: Hewlett Packard Enterprise Development LP, Spring, TX (US)

(72) Inventors: Mohan Parthasarathy, Bangalore (IN); Srinivasan Varadarajan Sahasranamam, Bangalore (IN); Venkatesh Nagaraj, Bangalore (IN)

(21) Appl. No.: 19/016,019

(22) Filed: Jan. 10, 2025

(30) Foreign Application Priority Data
Dec. 19, 2024 (IN) 202411100705

(51) Int. Cl. G06F 9/455

(52) U.S. Cl. CPC G06F 9/45558; G06F 2009/4557; G06F 2009/45595

(57) ABSTRACT

A server includes physical compute nodes. Each physical compute node includes a host and physical management resources. The physical management resources include a physical management processor. The server includes a distributed hypervisor to provide a distributed application operating environment that is hosted by the physical management resources. The distributed hypervisor to allocate, from the physical management processors, virtual processors for the distributed application operating environment to execute applications to manage the physical compute nodes. The distributed hypervisor includes a plurality of hyper-kernels that are associated with respective physical compute nodes. Each hyper-kernel is hosted on the physical management resources of the associated physical compute node.

### BACKGROUND

A server is a computer that provides, or serves, information to other computers (called "clients") for any of a number of different purposes. In examples, a server may execute monolithic applications, host microservices, provide data storage services, perform parallel processing tasks, or provide other functions or services.

### BRIEF DESCRIPTION OF THE DRAWINGS

FIG. 1 is a block diagram of a modular server that has a distributed management application operating environment architecture for executing management applications to manage the server, according to an example implementation.

FIG. 2 is a block diagram of a multiple node server illustrating details of the server's distributed management application operating environment architecture, according to an example implementation.

FIG. 3 is a sequence flow diagram depicting exemplary actions performed by a virtual rack management controller (RMC) to manage a modular server, according to an example implementation.

FIG. 4 is a flow diagram depicting a technique to add a node to a multiple node server that hosts a distributed management virtual machine, according to an example implementation.

FIG. 5 is a flow diagram depicting a technique to remove a node from a multiple node server that hosts a distributed management virtual machine, according to an example implementation.

FIG. 6 is a block diagram of a software-defined scale-up server that has a distributed management application operating environment architecture, according to a further example implementation.

FIG. 7 is a block diagram of a multiple node server having a distributed application operating environment hosted by physical management resources and in which management applications execute, according to an example implementation.

FIG. 8 is a block diagram of a system having multiple computer platforms, a distributed hypervisor and a virtual rack management controller to manage baseboard management controllers of the computer platforms, according to an example implementation.

FIG. 9 is a flow diagram depicted in a technique to aggregate compute nodes to provide a server and manage the server by hosting a virtual machine on baseboard management controllers of the compute nodes, according to an example implementation.

### DETAILED DESCRIPTION

A multiple node server (or "multi-node server") includes multiple compute nodes that work together as a single machine. A multiple node server may have any of a variety of different architectures. A modular server, which is built from a rack-mounted base chassis unit and one or multiple rack-mounted expansion chassis units, is one example of a multiple node server. Each chassis unit corresponds to a compute node and may be configured with a number of CPU packages, along with other resources (e.g., dual inline memory modules (DIMMs), Peripheral Component Interconnect express (PCIe) peripherals, and so forth).

In an example, each chassis unit includes a rack management processor (RMP) and a baseboard management controller (BMC). From the modular server's collection of RMPs, a single RMP is selected and designated to be the leader, or rack management controller (RMC) (also called a "monarch RMP"), for the modular server. The BMCs perform management functions for their respective chassis units. The RMC performs management functions for the modular server. More specifically, the RMC executes RMC management applications to collect information from the BMCs and process the collected information. The processing may be related to any of a number of server-related tasks, such as inventory management, fault management, telemetry value reporting, error analyses and logging.

In one approach, non-leader RMPs (i.e., the RMPs other than the RMP that is designated as the RMC) of the modular server are placed in idle states, which means that the resources of the non-leader RMPS are unused. An RMP may be a limited resource device (e.g., an embedded processor having a limited amount of memory). Consequentially, the functionalities and capabilities of the RMC management applications may be constrained by the limited resources available to support application execution.

In one approach to increase the amount of resources for RMC management application execution, all of the RMPs of the modular server are pooled together to host an orchestrated container cluster. With this approach, a monolithic RMC management application that would otherwise be executed by a single leader RMP (i.e., the RMC) is decomposed into a collection of microservices. In a microservice architecture, autonomous parts (called "microservices") of a monolithic application are hosted on respective worker nodes of an orchestrated container cluster. For a microservice-based RMC management application, the individual RMPs of the modular server serve as the worker nodes to host respective microservices of the application. A challenge with the orchestrated container cluster approach is the formidable coding task of transforming the traditional monolithic RMC management applications into respective microservice-based applications.

In accordance with example implementations that are described herein, a multiple node server has a distributed application operating environment (called a "distributed management application operating environment" herein) that is hosted by all RMPs of the server. Monolithic RMC management applications may run, or execute, in the distributed management application operating environment. More specifically, the RMPs of the server host respective hyper-kernels of a distributed hypervisor. The distributed hypervisor provides and manages a single virtual machine (the distributed management application operating environment) that runs across all RMPs. The distributed hypervisor allocates virtual resources (e.g., virtual CPUs and virtual memory) for the virtual machine from the underlying RMP physical resources (e.g., physical CPU cores and physical memory). In this way, the virtual machine corresponds to a virtual RMC that is supported by the physical resources of all of the server's RMPs.

As further described herein, in accordance with further example implementations, management controllers other than RMPs may host a distributed management application operating environment. In an example, a software-defined scale-up server includes compute nodes that have respective BMCs, and the BMCs host respective hyper-kernels of a distributed hypervisor. The distributed hypervisor provides and manages a single virtual machine that runs, or executes, across all BMCs of the server. The distributed hypervisor allocates virtual resources (e.g., virtual CPUs and virtual memory) for the virtual machine from the underlying BMC physical resources (e.g., physical CPU cores and physical memory). In this way, the virtual machine corresponds to a virtual BMC that is supported by the physical resources of all of the server's BMCs.

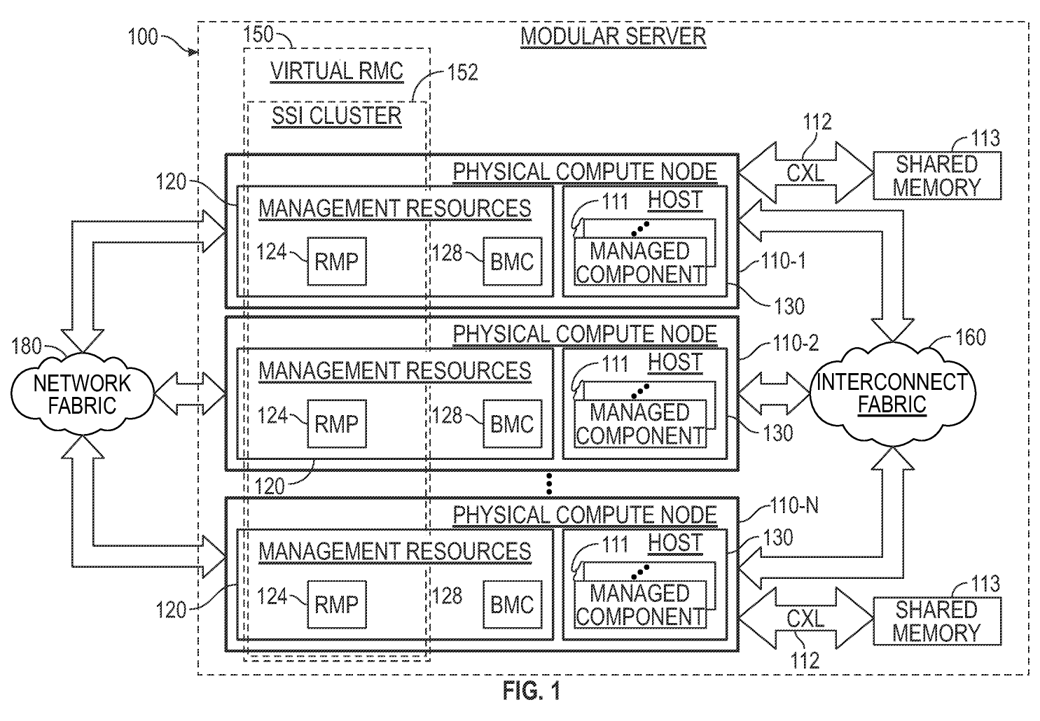

FIG. 1 depicts a modular server 100 in accordance with example implementations. The modular server 100 is an example of a multiple node server. The modular server 100 includes N compute nodes 110 (compute nodes 110-1, 110-2 and 110-N being depicted in FIG. 1). The compute nodes 110 correspond to respective chassis units of the modular server 100, and the compute nodes 110 are connected together by chassis unit interconnect fabric 160 (e.g., network cabling).

In an example, the modular server 100 includes a base chassis unit that corresponds to the compute node 110-1, and the modular server 100 includes expansion chassis units that correspond to respective compute nodes 110-2 to 110-N. In an example, the compute nodes 110 are rack-mountable. In an example, all compute nodes 110 of the modular server 100 are installed in the same rack. In an example, each compute node 110 includes a crossbar switch (e.g., a crossbar switch provided by an application specific integrated circuit (ASIC)) that, through the chassis unit interconnect fabric 160, connect CPU communication links (e.g., Ultra Path Interconnect (UPI) links) of the compute nodes 110 together.

The compute nodes 110 include network adapters that connect the modular server 100 to network fabric 180. In accordance with example implementations, the network fabric 180 may be associated with one or multiple types of communication networks, such as (as examples) Fibre Channel networks, Compute Express Link (CXL) fabric, dedicated management networks, local area networks (LANs), wide area networks (WANs), global networks (e.g., the Internet), wireless networks, or any combination thereof.

A "compute node," in the context that is used, refers to a computer platform. A "computer platform" is an assembly that includes a frame, or chassis, and hardware that is mounted to the chassis and which supports the execution of machine-readable instructions (or "software"). In an example, the compute nodes 110 are rack-based chassis units. In general, a "compute node" may be any processor-based device, such as a rack-mountable modular chassis unit, an enclosure-based server (e.g., a blade server), a rack mount server (e.g., a density line (DL) server), or a tower server.

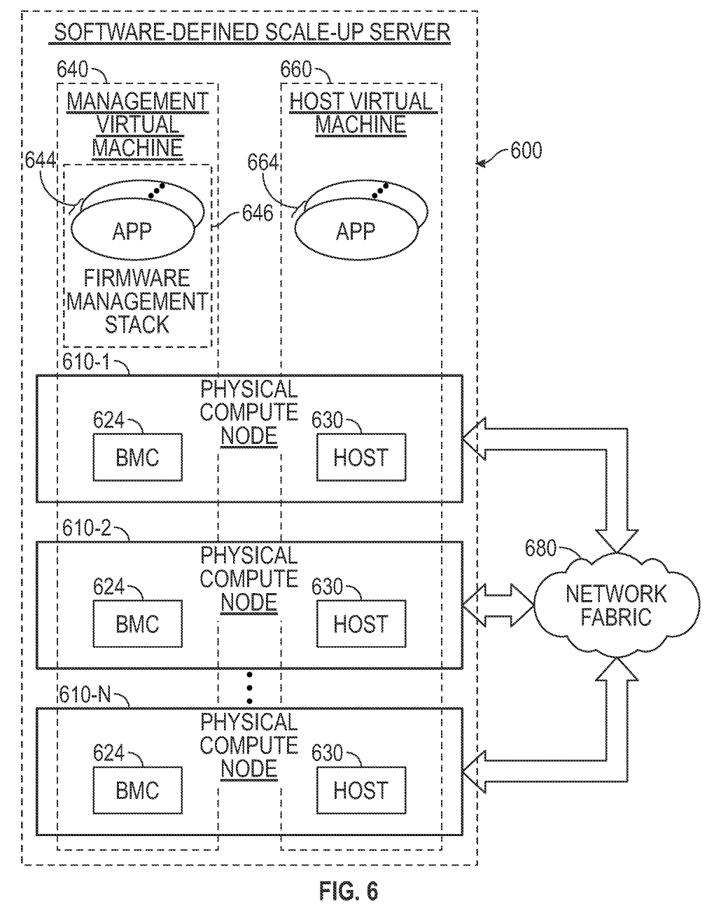

A modular server, such as example modular server 100, is just one example of a multiple node server. FIG. 6, which is described further herein, depicts a software-defined scale-up server that is another example of a multiple node server.

Regardless of its particular form or architecture, each compute node 110 includes one or multiple hosts 130 and management resources 120. In accordance with example implementations, the host(s) 130 and the management resources 120 are separate from each other and operate independently with respect to one another. In the context that is used herein, a "host" refers to an entity that has an unabstracted view of resources (e.g., physical memory, physical CPU cores, physical storage devices and a host operating system) of a compute node and provides one or multiple application operating environments in which application processes, or workloads, execute. In examples, an application operating environment may be a virtual machine, a container or a bare-metal server.

A host 130 may be associated with one or multiple managed components 111 that are managed by processes (called "management application processes," or "management application workloads") that are hosted by the management resources 120, as further described herein. A managed component 111 may be hardware or software. A power supply is an example of a managed component 111. A peripheral (e.g., an option card-based peripheral, such as a PCIe card-based peripheral) is another example of a managed component 111. A memory module (e.g., dual inline memory module (DIMM)) is another example of a managed component. A host operating system is another example of a managed component 111. System firmware is another example a managed component 111. The managed components 111 may be associated with sensors (e.g., a temperature sensor, a fan speed sensor or an intrusion sensor) that provide telemetry information for the management application workloads.

As depicted in FIG. 1, in accordance with example implementations, the management resources 120 include a BMC 128 and an RMP 124. The portion of the management resources 120 of a compute node 110 corresponding to the BMC 128 are referred to herein as the "BMC management resources 120." The portion of the management resources 120 of a compute node 110 corresponding to the RMP 124 are referred to herein as the "RMP management resources 120."

The BMC management resources 120 may include any of a variety of resources, such as one or multiple CPU cores, a memory and an operating system. The BMC management resources 120 host a management application operating environment. In the management operating environment, BMC management workloads run, or execute, for purposes of performing a variety of BMC management-related services for the BMC's compute node 110. In examples, the BMC management workloads may correspond to a BMC firmware management stack. In an example, the BMC management workloads monitor and manage the managed components 111 of the compute node 110. In another example, a BMC management workload monitors a host operating system. In another example, a BMC management workload takes an inventory of its compute node 110. In another example, a BMC management workload determines if the inventory is expected or unexpected based on a base platform certificate and any delta platform certificates. In another example, the BMC management workloads initialize resources of the compute node 110. In other examples, the BMC management workloads monitor sensors (e.g., temperature sensors, cooling fan speed sensors and intrusion sensors); report out-of-range sensor readings; report intrusion events; and log system events related to sensor measurements. Some BMC management workloads may be remotely-managed (e.g., managed by a management server in a different data center than the compute node 110 or in a different geographical location than the compute node 110). In examples, the remotely-managed BMC management workloads may perform such services as keyboard video mouse (KVM) services; virtual power services (e.g., services to place the compute node 110 in a particular power state, such as a power conservation state, a power on state, a reset state or a power off state); and services to manage virtual media.

The RMP management resources 120 include one or multiple CPU cores, a memory and an operating system. The RMP management resources 120 support the execution of RMC management workloads to manage the modular server 100. In examples, RMC management workloads collect, or aggregate, information from the BMCs 128 and perform various processing functions (e.g., inventory management, fault management, error analyses and logging) for the modular server 100 based on the aggregated information.

In an example, an RMC management workload gathers hardware component inventory of the modular server 100 (as reported by the BMCs 128) and reports the inventory to an administrative management node (not shown in FIG. 1). In another example, an RMC management workload reports a BMC-reported hardware fault to an administrative management node. In another example, an RMC management workload reports a BMC-reported software fault to an administrative management node. In another example, an RMC management workload reports a BMC-reported platform certificate mismatch event (i.e., the observed inventory differs from the expected inventory) to an administrative management node. In another example, an RMC management workload reports a BMC-reported unexpected software measurement to an administrative management node. In another example, an RMC management workload analyzes the BMC-reported telemetry measurements and detects anomalies or other problems as a result of the analysis. In another example, an RMC management workload logs BMC-reported compute node events. In another example, an RMC management workload initializes system firmware updates for the compute nodes 110. In another example, an RMC management workload initiates BMC firmware updates for the compute nodes 110.

Instead of using a single RMP 124 as the leader, or RMC, and leaving the RMP management resources 120 on the other compute nodes 110 unused, in accordance with example implementations, all of the RMPS 124 support RMC workload execution. Stated differently, the RMC management resources 120 from all compute nodes 110 are pooled together to form a single system image (SSI) cluster 152. In this context, an "SSI cluster" refers to a collection of separate processing entities, such as the RMPs 124, that appear to be a single processing entity.

For the example implementation that is depicted in FIG. 1, the SSI cluster 152 corresponds to a single virtual machine, called a "virtual RMC 150," which runs across all RMPs 124. Instead of an individual RMP 124 (the leader RMP, or RMC) executing RMC management workloads, the RMC management workloads run, or execute, inside the virtual RMC 150. In addition to the benefit of having all RMP management resources 120 supporting RMC management workload execution, monolithic RMC management applications may run in the virtual RMC 150 with little (in accordance with some example implementations) or no (in accordance with other example implementations) modifications.

In accordance with some implementations, the RMP management resources 120 for a particular compute node 110 may include shared memory that is not physically located on the compute node 110. In accordance with an example implementation, FIG. 1 depicts the compute nodes 110-1 and 110-N each having associated physical shared memory 113 (e.g., a shared CXL memory) that is located off the compute node 110 and is available via memory fabric connections, such as connections provided by CXL fabric 112. In an example, the CXL fabric 112 may include a collection of CXL switches (e.g., top-of-the-rack (ToR) switches) and interconnect cabling. In accordance with example implementations, one or multiple of the compute nodes 110 (e.g., the compute node 110-2) may not have an associated shared memory 113. Regardless of which compute nodes 110 have and do not have shared memory 113, in accordance with example implementations, the shared physical memory(ies) 113 are part of the RMP management resources 120 that support the RMC virtual machine 150. A CXL fabric manager (not shown) orchestrates the sharing of memory with the compute nodes 110.

In other examples, a shared memory 113 may be associated with a fabric-attached memory topology (e.g., a Remote Direct Memory Access (RDMA) topology or a Cache Coherent Interconnect for Accelerators (CCIX) topology, an Infiniband transport topology or a Fibre Channel transport topology). In other examples, the compute nodes 110 may have associated fabric-attached memories that are associated with a mixture of fabric-attached memory topologies.

In an example, the RMP management resources 120 of a first compute node 110 may access a shared memory 113 that is located on a second compute node 110. Continuing this example, the shared memory 113 may be shared by the first compute node 110, the second compute node 110 and possibly other computer nodes 110 of the modular server 100. In another example, the RMP management resources 120 of a first compute node 110 may be associated with a shared memory 113 that is located on a compute node that is not part of the modular server 100. Continuing this example, the compute nodes may be located in the same rack of a data center, and the shared memory 113 may be located in a server of the rack or located in a server that is installed in another rack of a data center.

In general, the memory devices that form the shared memories 113, physical memories of the host 130, the physical memories of the management resources 120, and other memories that that are described herein, are non-transitory hardware processor-readable (or "machine-readable") storage media. The storage media corresponds to a collection of memory devices, and in general, the storage media may be used for a variety of storage-related and computing-related functions. As examples, the memory devices may include semiconductor storage devices, flash memory devices, memristors, phase change memory devices, magnetic storage devices, a combination of one or more of the foregoing storage technologies, as well as memory devices based on other technologies. Moreover, the memory devices may be volatile memory devices (e.g., dynamic random access memory (DRAM) devices, static random access (SRAM) devices, and so forth) or non-volatile memory devices (e.g., flash memory devices, read only memory (ROM) devices and so forth), unless otherwise stated herein.

As used herein, a "BMC" (or "baseboard management controller") is a specialized service processor subsystem that monitors the physical state of a computer platform (or "compute node") and communicates with a management system through a management network. The BMC may communicate with host applications executing at the operating system level through an input/output controller (IOCTL) interface driver, a representational state transfer (REST) application programming interface (API), or some other system software proxy that facilitates communication between the BMC and the host applications. The BMC may have hardware level access to hardware devices of the host, including the host's system memory. The BMC may be able to directly modify hardware devices of the computer platform. The BMC may operate independently of the host's operating system. The BMC may be part of a semiconductor package that is located on the motherboard, or main circuit board, of the computer platform.

The fact that a BMC is mounted on a motherboard of the computer platform or is otherwise connected or attached to the computer platform does not prevent the baseboard management controller from being considered "separate" from the host of the computer platform. As used herein, a baseboard management controller has management capabilities for sub-systems of a computer platform and is separate from the processing resources that execute the host's operating system.

As used herein, an "RMP" is a specialized service processor subsystem that is constructed to manage a server that is formed from a collection of computer platforms (e.g., a modular server formed from a base expansion chassis unit and one or multiple expansion chassis units). As part of this management, the RMP is constructed to communicate with BMCs of respective computer platforms of the server. The RMP is constructed to collect information that is provided by the BMCs, process the information and communicate with a management system. In examples, processing the information includes analyzing telemetry metric values reported by BMCs, reporting software faults indicated by BMCs, reporting hardware faults indicated by BMCs, reporting telemetry metric summaries to the management system, logging computer platform events, and other functions related to analyzing information collected from the BMCs and managing the BMCs. The management system may communicate with the RMP through an IOCTL system call, a REST API call (e.g., a Redfish API call), or via some other system software proxy. An RMP may be part of a semiconductor package that is located on the motherboard, or main circuit board, of the computer platform.

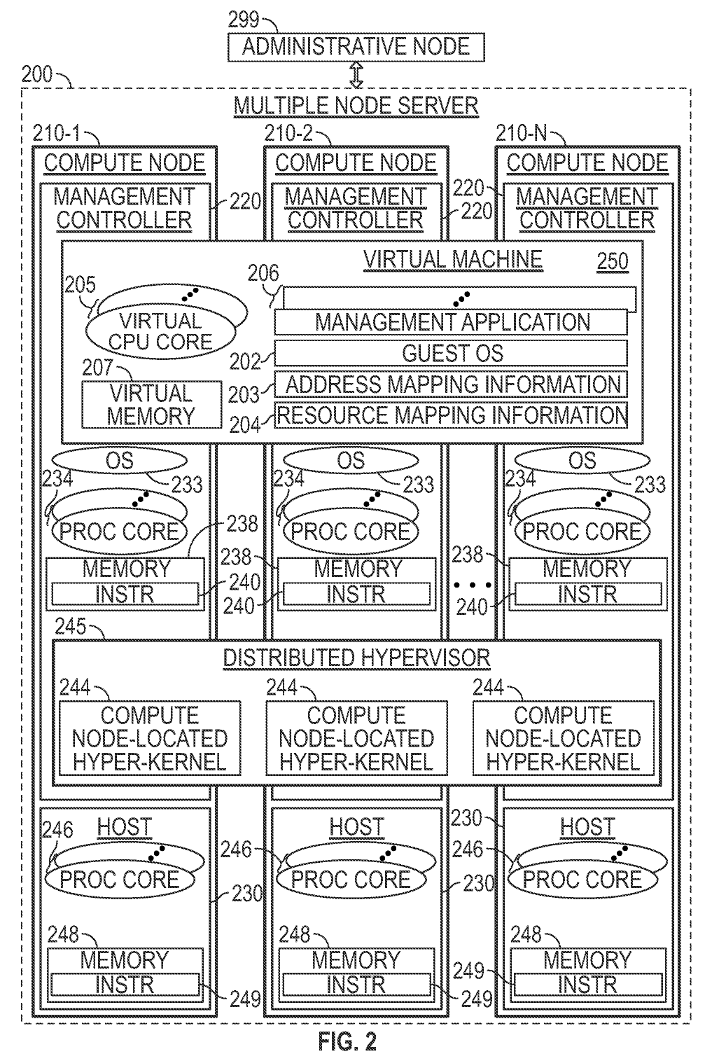

FIG. 2 is a block diagram of a multiple node server 200 in accordance with example implementations. In an example, the multiple node server 200 may be a modular server, such as the modular server 100 of FIG. 1. In another example, the multiple node server 200 may be a software-defined scale-up server, such as a software-defined scale-up server that is described further below in connection with FIG. 6. The multiple node server 200 may be managed by an administrative node 299. Managing the multiple node server 200 includes any of a variety of actions pertaining to configuring or maintaining the server 200, including such actions as configuring the number of compute nodes 210 of the server 200, adding a compute node 210 to the server, removing a compute node 210 from server 200, adding software, removing software, updating firmware, and so forth.

Referring to FIG. 2, the multiple node server 200 includes N compute nodes 210 (compute nodes 210-1, 210-2 and 210-N, being depicted in FIG. 2). The compute node 110 of FIG. 1 is an example of the compute node 210. Each compute node 210 includes a management controller 220. Depending on the particular implementation, the management controllers 220 may be the same or may be a heterogeneous mixture of architectures and resource compositions. In an example, the management controller 220 is an RMP (e.g., the RMP 124 of FIG. 1). In another example, the management controller 220 is a BMC (e.g., the BMC 128 of FIG. 1).

The management controller 220 has an associated set of physical management resources, such as one or multiple physical processor cores 234 (e.g., physical CPU cores) and a collection of physical memory devices corresponding to a physical memory 238. The memory 238 may store instructions 240 that are readable and executable by one or multiple processor cores 234. The management controller 220 may have other physical resources (e.g., a network adapter) that are not depicted in FIG. 2. The management controller 220 has an operating system 233.

In accordance with example implementations, the management controllers 220 are grouped together as an SSI cluster. As depicted in FIG. 2, a virtual machine 250 (called the "management virtual machine 250" herein) corresponding to an SSI cluster runs across (or is "distributed across") the management controllers 220 of the compute nodes 210. Stated differently, the physical management resources of all compute nodes 210 collectively host the management virtual machine 250. Although FIG. 2 depicts a single management virtual machine 250, in accordance with further implementations, the multiple node server 200 includes multiple management virtual machines, and each of these management virtual machines runs across all of the compute nodes 210.

The management virtual machine 250 corresponds to a distributed application operating environment that supports the execution of one or multiple management applications 206. Moreover, the distributed application operating environment has a distributed guest operating system 202. The management virtual machine 250 has an allocation of virtual resources. As depicted in FIG. 2, the virtual resources include virtual CPU cores 205 (also called "virtual CPUs 205" herein) and a virtual memory 207.

In an example, the management controllers 220 are RMPs, and the management applications 206 are RMP management applications that are designed to be executed by a single monarch RMP 220 (e.g., a RMP 220 is designated as the leader, or "RMC"). With the management virtual machine 250, however, the execution of a given RMP management application 206 is supported by multiple, if not all, of the N RMPs 220. Moreover, a given RMP management application 206 may execute, or run, inside the management virtual machine 250 with little (in accordance with some implementations) or no (in accordance with other implementations) modification.

In another example, the management controllers 220 are BMCs, and the management applications 206 are BMC applications that are designed to be executed by a single BMC 220 (e.g., a collection of monolithic management applications 206 on each compute node 210, which are executed by a single BMC 220). Due to the distributed application operating environment that is provided by the management virtual machine 250, however, a given BMC management application 206 is executed using the resources of potentially multiple, if not all, BMCs 220. Moreover, although a given BMC management application 206 may be designed to be executed by a single BMC, the BMC management application 206 may instead run, or execute, in the management virtual machine 250 with little (in accordance with some implementations) or no (in accordance with other implementations) modification.

For such purposes as providing the virtual resources for and managing the management virtual machine 250, the multiple node server 200 includes a distributed hypervisor 245. More specifically, the distributed hypervisor 245 abstracts the physical resources of the management controllers 220 to provide the virtual resources (e.g., the virtual CPUs and virtual memory 207) for the management virtual machine 250. In an example, the distributed hypervisor 245 is a type one hypervisor that runs directly on the management controllers 220 without an intervening operating system. In another example, the distributed hypervisor 245 is a type two hypervisor that runs on an operating system, which, in turn, runs on the management controller resources.

The distributed hypervisor 250 includes hyper-kernels 244 that are deployed, or located, on respective compute nodes 210. Each hyper-kernel 244 is formed by one or multiple of the physical processing cores 234 of the compute node 210 executing instructions. The distributed hypervisor 245 provides a hyper-kernel physical address space. Address mapping information 203 is maintained for the management virtual machine 250. The address mapping information 203 maps guest virtual memory addresses of a guest physical memory address space to physical addresses of the hyper-kernel physical address space. From the point of view of the guest operating system 202, the guest physical memory is treated as a physical memory. However, the guest physical memory is actually a virtual memory that is provided by the distributed hypervisor 245.

In accordance with example implementations, the hyper-kernels 244 perform the mapping of guest physical memory addresses to real physical memory addresses. The guest operating system 202 performs the mapping of guest virtual memory addresses to guest physical memory addresses (using first level page table mappings). From the viewpoint of the guest operating system 202, the guest physical memory addresses appear to be real physical memory addresses but are not. The management virtual machine 250 maintains a virtual resource map that describes, from the point of view of the guest operating system 202, the virtual resources that are available to the guest operating system 202. In accordance with example implementations, the hyper-kernels 244 use second level page table hardware and second level address mapping information to map guest physical memory addresses to real physical memory addresses. Each hyper-kernel 244 has address mapping information that, from the viewpoint of the hyper-kernel 244, is a current resource mapping between the virtual resource map and the physical resources that are managed by the hyper-kernel 244. In accordance with example implementations, each hyper-kernel 244 has resource mapping information that describes the physical resources that are managed by the hyper-kernel 244.

The hyper-kernels 244 communicate with each other to collectively perform the tasks of the distributed hypervisor 245. Each hyper-kernel 244 can observe the system's management plane running in real time and optimize its respective management resources to match the requirements of the management plane during operation. The hyper-kernels 244 unify the physical resources of the management controllers 220 and present the unified set to the guest operating system 202. Because of the abstraction provided by the hyper-kernels 244, the guest operating system 202 has the view of a single large management controller that contains an aggregated set of processors, memories, I/O resources, network communication resources, and so forth.

The distributed hypervisor 245 presents, to the guest operating system 202, virtual CPUs 205 that are virtualized representations of the physical processor cores 234. As an example, if there are five management controllers 220 (corresponding to five compute nodes 210) and each management controller 220 has two physical processor cores 234, then the distributed hypervisor 245 presents the guest operating system 202 with ten virtual CPUs 205 that are part of a single virtual management controller.

In accordance with some implementations, the distributed hypervisor 245 uses resource mapping information 204 to translate between virtual and physical configurations. In an example, the resource mapping information 204 includes a physical resource map that describes the physical resources that are available on each management controller 220. In an example, the resource mapping information 204 includes an initial resource map that describes the virtual resources that are available from the point of view of the operating system. In an example, the resource mapping information 204 includes a current resource map that is maintained by each hyper-kernel 244 and describes the current mapping between the virtual resource map and the physical resource map from the point of view of each management controller 220.

The distributed hypervisor 245 provides an adaptive and reconfigurable framework. This framework allows the changing, or modifying, of the set of underlying hardware components that support the management virtual machine 250, while the guest operating system 202 and the management applications 206 run uninterrupted while the modification occurs.

In accordance with example implementations, physical hardware components of the management controllers 220 are grouped, and these groups are associated with respective resilient logical modules (also called "logical modules" herein). Virtual resources (e.g., virtual memory pages, virtual CPUs, virtual input/output (I/O) devices) are mobile among the compute nodes 210 and are dynamically reconfigurable. To support this mobility, the distributed hypervisor 245 is constructed to add and remove sufficient physical resources that support the virtual resources, and automatically re-map the virtual resources to additional or different physical resources. This provides high availability for the management controller resources that support the management virtual machine 250.

An advantage of the high availability is that a compute node 210 may be removed from the multiple node server 200 or added to the multiple node server 200 dynamically while management applications 206 execute and without affecting the management application execution. This high availability allows, for example, a compute node 210 to be removed from the multiple node server 200 and serviced (e.g., removed for scheduled maintenance or repair) or replaced without affecting management functions of the multiple node server 200. The high availability also allows a compute node 210 to be added to the multiple node server 200 without affecting management functions of the serve 200. For example, a compute node 210 that has undergone a scheduled maintenance may be added back to the multiple node server 200. In another example, a compute node 210 may be added to the multiple node server 200 to increase, or upscale, the server's capacity.

Reconfiguring the management resources of the multiple node server 200 includes binding and unbinding logical modules to physical components, and binding and unbinding virtual machine components to logical modules. The distinction between logical modules and physical components is a form of virtualization (albeit, a type of virtualization different from the virtualization of processors, memory, and I/O devices to create a virtual machine that is performed by the distributed hypervisor 245). In accordance with example implementations, the distributed hypervisor 245 is divided into two layers. A lower layer of the distributed hypervisor 245 includes logical modules (described in further detail below), which manage certain physical management resources. An upper layer of the distributed hypervisor 245 manages logical modules on any compute node 210.

As the logical module is not hardware, the logical module may be migrated. That is, a logical module implementation is free to migrate its use of physical components, and physical components may be moved transparently. The distributed hypervisor 245 performs the migration of logical modules without the knowledge of the guest operating system 202. That is, this layer of logical modules is hidden from the guest operating system 202. Therefore, the distributed hypervisor 245 runs on a collection of logical modules that are bound at any particular time to physical components.

In accordance with example implementations, the distributed hypervisor 245 abstracts the physical management components into logical modules that may be grouped, or categorized, into a number of logical module types: node, time base, net port and storage volume. A node logical module corresponds to a particular hyper-kernel 244. Internally, the node logical module has CPUs and memory. A node logical module may also hold other logical components of the other logical module types. Holding represents a higher-level aspect of reconfigurability. The time base logical module represents the time base that is used to synthesize virtual timestamp-counters and various virtual hardware clocks in the system. The bus port logical module represents a high-speed interconnection from a logical node to the other logical nodes that are attached to an Internet switch. In accordance with example implementations, there is one bus port logical module in each operational node logical module. A net port logical module represents a network interface port. A storage volume logical module represents a logical drive controller.

Physical components of a distributed logical module may span multiple compute nodes 210. Logical modules may relocate, at any time, the function to span a different set of nodes. The guest operating system 202 is unaware of the relocation. The relocation process introduces no disruption in function.

In accordance with example implementations, the dynamic reconfiguration framework is implemented in part by an API that is used by the distributed hypervisor 245. The API may include commands issued to logical modules as procedure calls. In accordance with example implementations, a dedicated interconnect is used to turn a local procedure call into a remote procedure call.

In accordance with example implementations, logical modules are used to manage the physical processor cores 234. In an example, a logical module is implemented as a thread data structure in an operating system 233 of a management controller 220. This allows, for example, the distributed hypervisor 245 to present a standardized virtual CPU to the guest operating system 202. The physical processor cores 234 across the compute nodes 210 may be heterogeneous, with different capabilities, not all of which are presented to the guest operating system 202. The logical module corresponding to the standardized virtual CPU includes information defining what capabilities of the corresponding physical processor core 234 is provided and is not provided. Thus, a standardized set of identical virtual CPUs may be presented to the guest operating system 202, even if the physical processor cores 234 are different.

Logical modules may also be used to manage virtual memory page migration. In an example, a logical module is associated with a virtual memory page and includes information about the page. When a page of virtual memory is migrated, the corresponding logical module is also migrated as well.

Logical modules may also be used to manage virtual network adapters. In an example, a logical module is associated with a virtual network adapter that is implemented by the two different physical network adapters on two different management controllers 220. The logical module is part of a particular hyper-kernel 244. The logical module includes the information about the two physical network adapters (e.g., location information), and makes decisions about which of the physical network adapters is used to implement a request by the guest operating system 202 to the virtual network adapter. That is, the internal structure of the logical module includes such information about how to apply instructions to the different physical adapters.

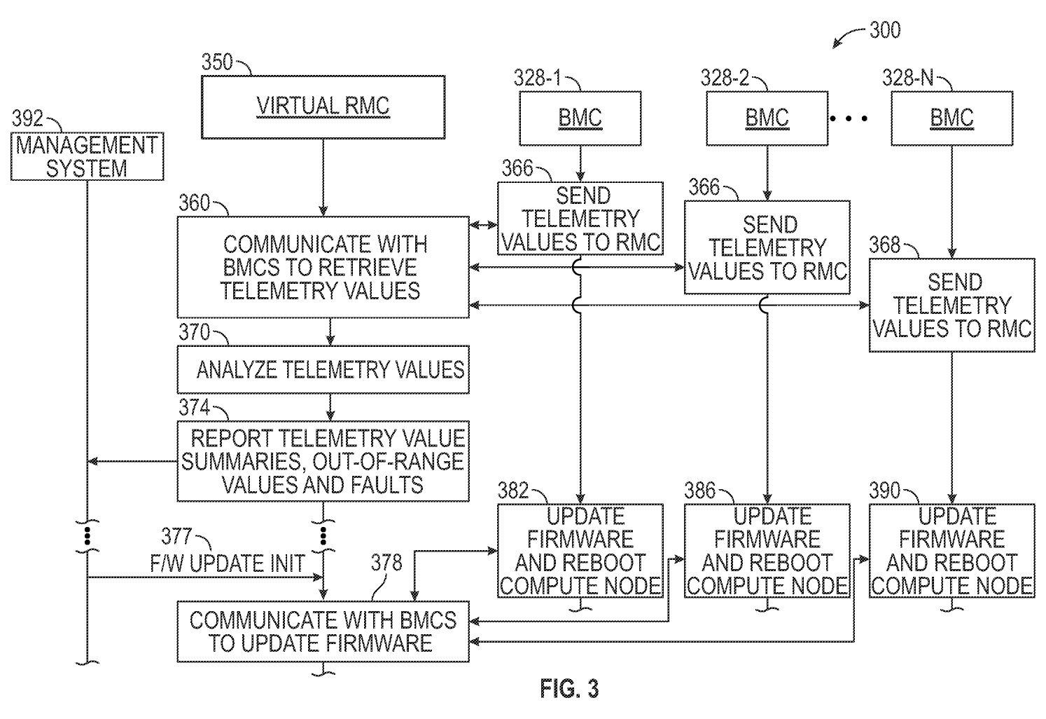

FIG. 3 is a sequence flow diagram 300 depicting exemplary actions performed by a virtual RMC 350 to manage a multiple node server in accordance with example implementations. The virtual RMC 350 is supported by the resources of multiple RMPs. For this example, the multiple node server includes N compute nodes, with each compute node including an RMP and a BMC 328. Example BMCs 328-1, 328-2 and 328-N are depicted in FIG. 3. The modular server 100 of FIG. 1 and the multiple node server 200 of FIG. 2 are examples of the multiple node server associated with FIG. 3.

In an example, the virtual RMC 350, as depicted at 360, communicates with the BMCs 328 to retrieve telemetry values from the BMCs. As depicted in FIG. 3, the BMCs 328-1, 328-2 and 328-N send (as depicted at 364, 366 and 368, respectively) the telemetry values to the virtual RMC 350. In examples, the telemetry values may be temperature sensor measurements, cooling fan speed measurements, voltages, or other indicators of health and/or performance of the multiple node server.

As depicted at 370, the virtual RMC 350 analyzes the telemetry values. In an example, the analysis of the telemetry values may include the virtual RMC 350 averaging telemetry values. In another example, the analysis may include the virtual RMC 350 identifying any telemetry values that are out of their respective ranges. In another example, the analysis includes the virtual RMC 350 identifying any hardware faults represented by the telemetry values. In another example, the analysis includes the virtual RMC 350 identifying software faults. In another example, the analysis includes the virtual RMC 350 predicting failures and/or performance issues with the multiple node server.

As depicted at 374, the virtual RMC 350 may then report information to a management system 392 (e.g., report to a remote management server). In particular, in accordance with example implementations, the virtual RMC 350 may report telemetry value summaries, out-of-range values, faults, as well as other information to the management system 392.

The virtual RMC 350 may perform various other functions related to managing the multiple node server. In another example, as depicted in FIG. 3, the virtual RMC 350 receives, from the management system 392, a request 377 to initiate a firmware update on the multiple node server. In an example, the firmware update may involve updating a system firmware of each compute node, such as, for example, updating a Unified Extensible Firmware Interface (UEFI) image and/or updating a basic input/output system (BIOS) image. In another example, updating the firmware includes updating a firmware image corresponding to instructions that are executed by the BMCs 328. In an example, the firmware image may correspond to a BMC firmware management stack.

Regardless of the particular type of firmware update, in accordance with example implementations, the BMCs 328 manage the firmware upgrade on their respective compute nodes. Accordingly, as depicted at 378, the virtual RMC 350 communicates with the BMCs 328 to update the firmware. In response to this communication, as depicted at 382, 386 and 390, each BMC 328 updates the firmware on its compute node and then reboots its compute node.

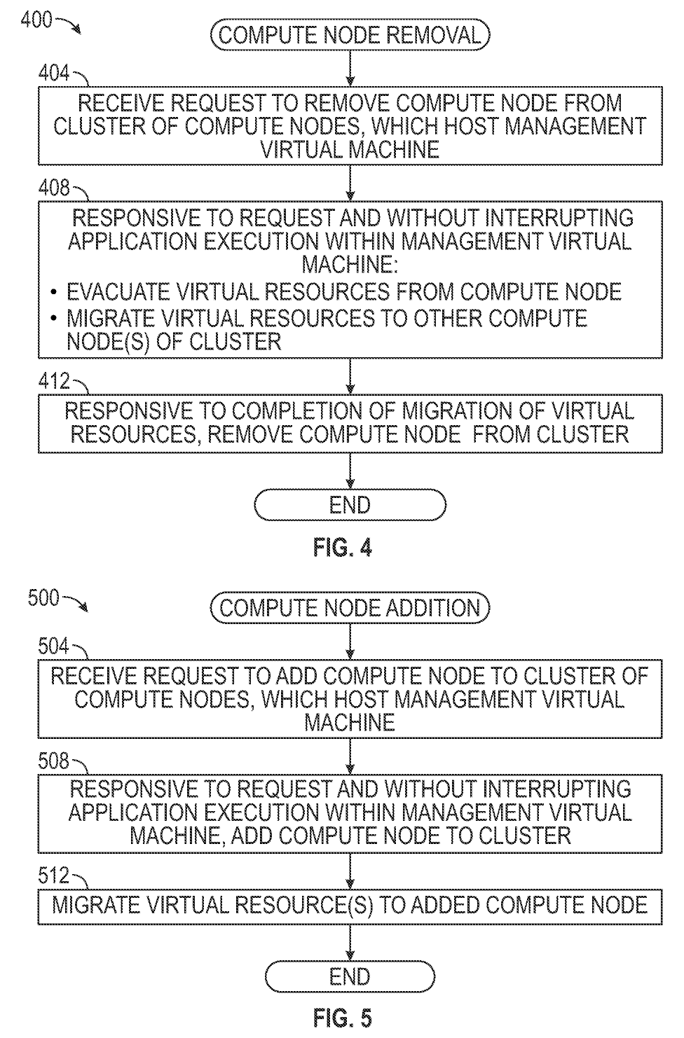

FIG. 4 depicts an example technique 400 for dynamically removing a compute node (e.g., a compute node 110 of FIG. 1 or a compute node 210 of FIG. 2) from a cluster of compute nodes (e.g., the server 100 of FIG. 1 or the multiple node server 200 of FIG. 2) dynamically without interrupting any ongoing management functions. Stated differently, the removal of the compute node does not interrupt the execution of management applications (e.g., the management applications 206 of FIG. 2) inside a management virtual machine (e.g., the management virtual machine 250 of FIG. 2) that is hosted on the cluster, including the compute node that is being removed. In an example, a compute node may be removed for scheduled maintenance or removed for another purpose, such as a repair of the compute node or the replacement of the compute node with another compute node. In an example, a distributed hypervisor (e.g., the distributed hypervisor 245 of FIG. 2) performs the technique 400.

Referring to FIG. 4, pursuant to block 404, the distributed hypervisor receives a request to remove a compute node (called the "evacuated compute node" herein) from a cluster that hosts a management virtual machine. In an example, the request originates with an administrative node (e.g., the administrative node 299 of FIG. 2) that manages the cluster. In an example, an IT administrator initiates the request via a GUI that is hosted on the administrative node. In another example, software of the administrative node automatically generates the request in accordance with a maintenance schedule. In other examples, the request is manually or automatically generated in response to a detected failure of the evacuated compute node.

Pursuant to block 408, responsive to the request and without interrupting application execution inside the management virtual machine, the distributed hypervisor evacuates, or removes, virtual resources from the evacuated compute node. Moreover, pursuant to block 408, the distributed hypervisor moves, or migrates, resources associated with the evacuated compute node to one or multiple other compute nodes of the cluster.

In accordance with example implementations, for purposes of evacuating the virtual resources from the evacuated compute node, the distributed hypervisor ensures that the corresponding node logical module (called the "evacuated node logical module") does not contain any guest state. More specifically, in accordance with example implementations, the distributed hypervisor removes guest memory pages, virtual CPUs and virtual I/O devices from the evacuated node logical module. In accordance with example implementations, all virtual pages are mobile among the node logical modules (i.e., no “wired” pages), such that the virtual pages may be moved at any time. In an example, guest pages are not mapped to user space. In an example, I/O device emulations deal with pages that move by stalling on access to a non-local page. After stalling, the non-local page is either moved to the node logical module where the emulation is running, or else moving the I/O device emulation thread is moved to the node logical module containing the virtual page.

The evacuation of resources from the evacuated compute node is part of an evacuation phase. As part of the evacuation phase, the evacuated node logical module informs all node logical modules that the evacuated node logical module is no longer a destination for migration of virtual CPUs, guest virtual pages or virtual I/O devices. The evacuated node logical module may still receive requests for resources, which the module handles or forwards as appropriate during the evacuation phase. Next, the evacuated node logical module begins evacuating pages, virtual CPUs, and virtual I/O devices that are present.

In accordance with example implementations, each evacuated resource generates a special location update message, which is broadcast, by the evacuated node logical module, to all other node logical modules indicating that a resource has moved from the evacuated logical node module to the new node logical module. In accordance with example implementations, evacuation location updates are bundled into messages. When the evacuation is complete, the node logical module broadcasts an evacuation complete message (indicating completion of the evacuation of resources) and waits for response from all other node logical modules (acknowledging receipt of the evacuation completion message). While waiting for acknowledgements of the evacuation complete message, the evacuation logical node module handles evacuation location request(s) responding with evacuation location update messages.

Pursuant to block 412 of the technique, the distributed hypervisor removes the evacuated compute node from the cluster. In accordance with example implementations, the distributed hypervisor removes the evacuated compute node response to all of the remaining node logical modules acknowledging receipt of the evacuation completion message sent by the evacuated node logical module.

FIG. 5 depicts an example technique 500 for dynamically adding a compute node (called the "added compute node" herein) to a cluster dynamically without interrupting any ongoing management functions. In an example, the added compute node may have been previously removed for scheduled maintenance. In another example, the added compute node may replace a compute node that was removed from the cluster (e.g., a compute node removed due to failure, maintenance or the scaling down of the cluster). In another example, a compute node may be added due to the scaling up of compute nodes of the cluster. In an example, a distributed hypervisor (e.g., the distributed hypervisor 245 of FIG. 2) performs the technique 500.

Referring to FIG. 5, pursuant to block 504, the distributed hypervisor receives a request to add a compute node (the "added compute node") to a cluster of compute nodes that host a management virtual machine. In an example, the request originates with an administrative node (e.g., the administrative node 299 of FIG. 2) that manages the cluster. In an example, an IT administrator initiates the request via a GUI that is hosted on the administrative node.

Pursuant to block 508, responsive to the request and without interrupt application execution inside the management virtual machine, the distributed hypervisor adds the added compute node to the cluster. In this context, "adding" a compute node to the cluster means that compute node is available for virtual resources to be migrated to the compute node and available for virtual resources to be migrated from the compute node. In accordance with example implementations, adding a compute node to the cluster includes the distributed hypervisor creating a node logical module for the compute node.

Pursuant to block 512, after adding the added compute node to the cluster, the distributed hypervisor may then migrate virtual resources to the added compute node. In an example, the distributed hypervisor may migrate such virtual resources as virtual pages, virtual CPUs and virtual I/O devices to the corresponding node logical module. In a similar manner, the distributed hypervisor may migrate virtual resources from the node logical module.

FIG. 6 depicts a software-defined scale-up server 600 (also called the "server 600" herein) in accordance with example implementations. The server 600 is another example of a multiple node server. Similar to the other multiple node servers that are described herein, the server 600 includes N physical compute nodes 610 (example compute nodes 610-1, 610-2 and 610-N being depicted in FIG. 6). The physical compute node 610 may be interconnected by network fabric 680. In an example, the compute node 610 may be located in the same rack of a data center. In another example, the compute nodes 610 may be distributed among multiple racks of a data center. For this example implementation, each physical compute node 610 includes a host 630 and a BMC 624 that manages the host 630.

In accordance with example implementations, the BMCs 624 are pooled together as an SSI cluster. In this manner, a management virtual machine 640 corresponding to the SSI cluster is distributed across the BMCs 624. As such, the BMCs 624 correspond to a collection of physical resources that host the management virtual machine 640. The management virtual machine 640, in turn, corresponds to a virtual BMC in which BMC management application 644 execute, or run, to manage the server 600.

In accordance with example implementations, the BMC management applications 644 correspond to a firmware management stack. In an example, the firmware management stack is an OpenBMC firmware management stack. In accordance with some implementations, due to the distributed application operating environment provided by the management virtual machine 640, the BMC management application 644 may be unmodified, monolithic applications that are designed to execute on a single BMC.

Although not depicted in FIG. 6, in accordance with example implementations, a distributed hypervisor runs across the compute nodes 610. In this manner, in accordance with example implementations, each compute node 610 hosts a hyper-kernel, and collectively, the hyper-kernels form the distributed hypervisor. Moreover, although not depicted in FIG. 6, the management virtual machine 640 includes a distributed guest operating system that runs across the compute nodes 610. The distributed hypervisor 245 and hyper-kernels 244 of FIG. 2 are examples of the distributed hypervisor and hyper-kernels of the management virtual machine 640.

The server 600, in addition to the management virtual machine 640, includes a single host virtual machine 660 that is distributed across the compute nodes 610. Resources of the hosts 630 of the compute nodes 610 hosts the host virtual machine 660. Application 664 may therefore run, or execute, in the host virtual machine 660. The host virtual machine 660 corresponds to an SSI cluster of the hosts 630. Moreover, management of the host virtual machine 660, including providing the abstracted virtual resources for the host virtual machine 660, is provided by a distributed hypervisor that runs across the compute nodes 610. The distributed hypervisor includes a collection of hyper-kernels that are executed by respective hosts 630. Moreover, the host virtual machine 660 includes a guest operating system that is distributed across the compute node 610 and hosted by host resources. In accordance with further implementations, the server 600 includes one or multiple additional host virtual machines that each run across the compute nodes 610.

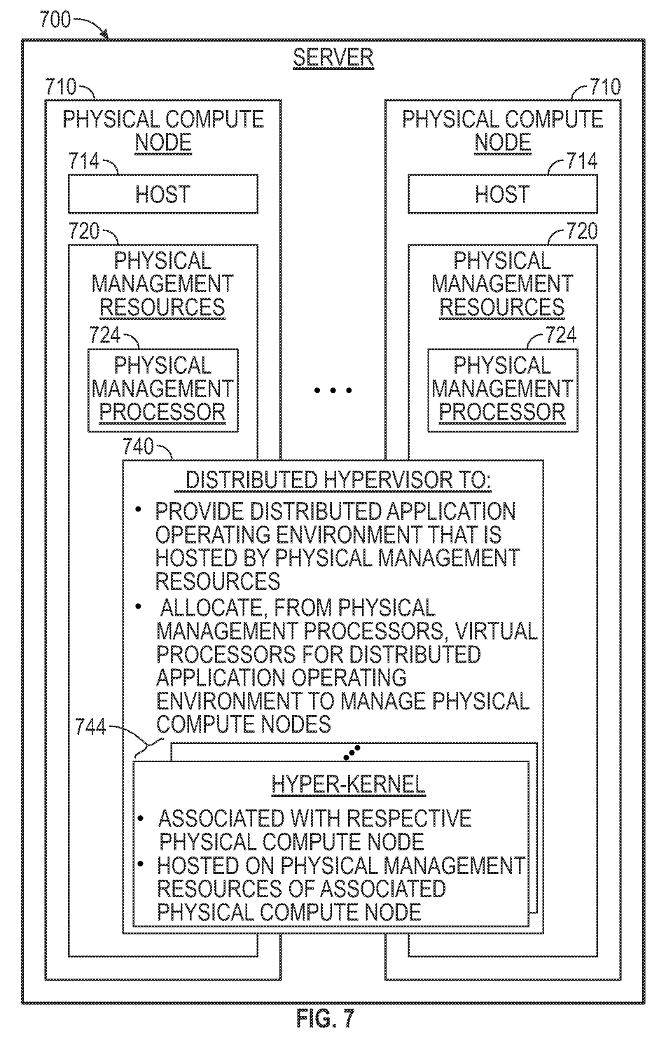

Referring to FIG. 7, in accordance with example implementations, a server 700 includes a plurality of physical compute nodes 710. Each physical compute node 710 includes a host 714 and physical management resources 720 that are separate from the host 714. The physical management resources 720 includes a physical management processor 724. In an example, the server is a modular server that includes multiple chassis units. In another example, the server 700 is a software-defined scale-up server. In an example, the physical management resources 720 are associated with a BMC. In another example, the physical management resources 720 are associated with an RMP. In an example, the physical management processor 724 is a collection of one or multiple CPU cores.

The server 700 further includes a distributed hypervisor 740 to provide a distributed application operating environment that is hosted by the physical management resources 720. In an example, the distributed application operating environment is a virtual machine. In an example, the distributed hypervisor 740 is a type one hypervisor. In another example, the distributed hypervisor 740 is a type two hypervisor.

The distributed hypervisor 740 allocates, from the physical management processors 724, virtual processors for the distributed application operating environment to execute applications to manage the physical compute nodes 710. In an example, the virtual processors are virtual CPU cores. In an example, the applications are RMP management applications. In another example, the applications are BMC management applications. In another example, the applications correspond to a BMC firmware management stack.

In an example, managing the physical compute nodes 710 includes managing the hosts 714. In an example, managing the physical compute nodes 710 include performing BMC-related tasks. In an example, a BMC-related task identifies software faults. In another example, a BMC-related task identifies hardware faults. In another example, a BMC-related tasks identifies out-of-range telemetry values. In another example, a BMC-related task identifies a platform certificate mismatch. In another example, a BMC-related task manages virtual media.

In another example, the applications are RMC applications that manage RMC-related tasks. In an example, an RMC-related task aggregates information provided by BMCs of the compute nodes 710. In an example, an RMP-related task is logging events associated with the compute nodes 710. In an example, an RMP-related task is analyzing information provided by BMCs of the compute nodes 710.

The distributed hypervisor 740 includes a plurality of hyper-kernels 744 that are associated with respective physical compute nodes 710. Each hyper-kernel is hosted on the physical management resources 720 of the associated physical compute node 710. In an example, the hyper-kernels 744 communicate with each other to collectively form tasks of the distributed hypervisor 740. In an example, each hyper-kernel 744 observes the system's management plane running in real time and optimizes its respective management resources to match the requirements of the management plane during operation. In an example, the hyper-kernels 744 unify the physical management resources 720 and present the unified set to a distributed guest operating system. In an example, because of the abstraction provided by the hyper-kernel 744, the guest operating system has the view of a single large management controller that contains an aggregated set formed from the collection of physical management resources 720 provided by the physical compute nodes 710.

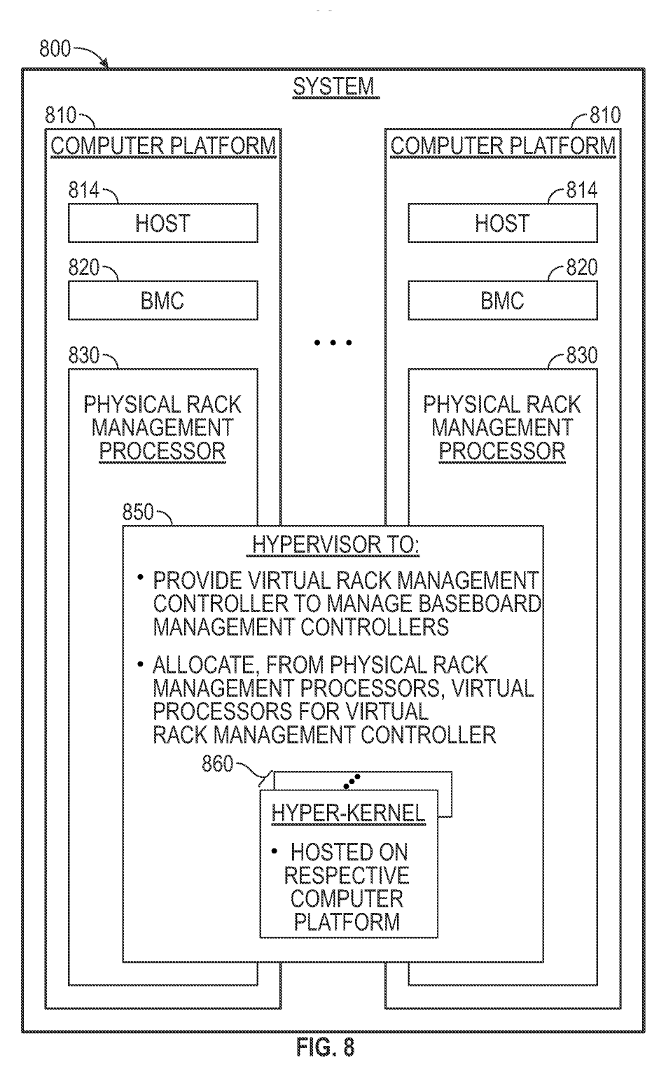

Referring to FIG. 8, in accordance with example implementations, a system 800 includes a plurality of computer platforms 810 and a hypervisor 850. In an example, the system 800 is a modular server, and the plurality of computer platforms 810 are respective rack-mounted chassis units. In another example, the system 800 is a software-defined scale-up server, and the computer platforms 810 may be located in the same rack or different racks of a data center. In examples, the computer platforms 810 may be rack enclosure-based servers, rack mount servers or tower servers. In an example, the hypervisor 850 is a type one hypervisor. In another example, the hypervisor 850 is a type two hypervisor.

Each computer platform 810 includes a host 814, a baseboard management controller 820 and a physical rack management processor 830. In an example, the baseboard management controller 820 operates independently from the host 814 for purposes of managing the host 814. In an example, the baseboard management controller 820 monitors the host 814 for software faults. In an example, the baseboard management controller 820 manages the host 814 for hardware faults. In an example, the baseboard management controller 820 detects out-of-range telemetry values associated with the host 814. In an example, the baseboard management controller 820 is powered by an auxiliary power supply that is separate from a main power supply associated with the host 814. In an example, the baseboard management controller 820 reports information about the host 814 to a rack management controller. In an example, the physical rack management processor 830 is constructed to function as a rack management controller. In an example, the baseboard management controller 820 includes one or multiple physical processing cores and a physical memory. In an example, the rack management processor 830 includes one or multiple processing cores and a physical memory.

The hypervisor 850 is distributed across the computer platforms 810 to provide a virtual rack management controller to manage the baseboard management controllers 820. In an example, the virtual rack management controller corresponds to a single virtual machine that is distributed across the computer platforms 810. In an example, monolithic rack management controller applications execute in the virtual machine. In an example, the virtual rack management controller aggregates information provided by the baseboard management controllers 820. In an example, the virtual rack management controller analyzes information provided by the baseboard management controllers 820. In an example, the virtual rack management controller reports information about the computer platforms 810 to a management system. In an example, the virtual rack management controller logs events reported by the baseboard management controllers 820.

The hypervisor 850 allocates, from the physical rack management processors 830, virtual processors for the virtual rack management controller. In an example, the virtual processors are virtual CPU cores. In an example, the virtual processors execute rack management controller applications for the virtual rack management controller. In an example, the hypervisor 850 further allocates virtual memory for the virtual rack management controller from physical memories associated with the physical rack management processors 830.

The hypervisor 850 includes a plurality of hyper-kernels 860. The hyper-kernels 860 are hosted on respective computer platforms 810. In an example, the hyper-kernels 844 communicate with each other to collectively form tasks of the distributed hypervisor 840. In an example, each hyper-kernel 844 observes the system's management plane running in real time and optimizes its respective management resources to match the requirements of the management plane during operation. In an example, the hyper-kernels 844 unify the physical management resources 820 and present the unified set to a distributed guest operating system. In an example, because of the abstraction provided by the hyper-kernel 844, the guest operating system has the view of a single large management controller that contains an aggregated set formed from the collection of physical management resources 820 provided by the physical compute nodes 810.

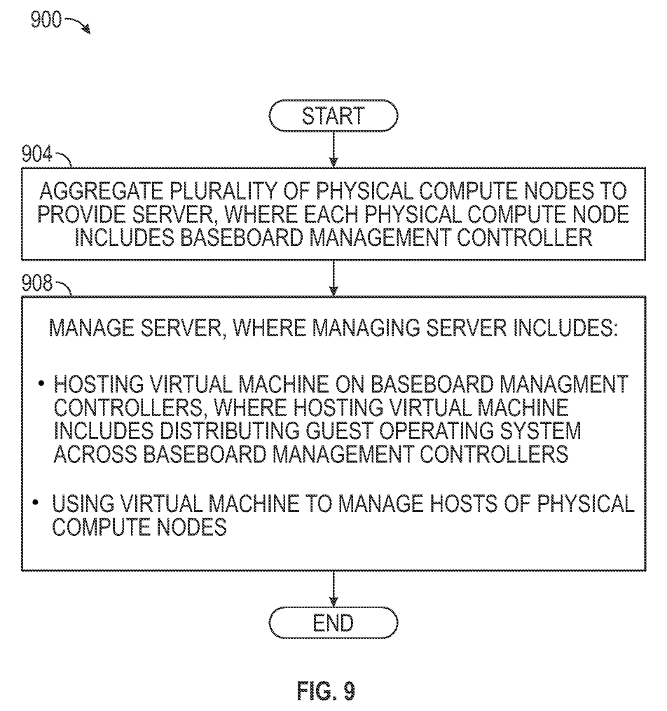

Referring to FIG. 9, in accordance with example implementations, a technique 900 includes aggregating (block 904) a plurality of physical compute nodes to provide a server. In an example, aggregating the plurality of physical compute nodes includes forming a modular server from multiple rack-mounted chassis units. In another example, aggregating the plurality of physical compute nodes includes forming a software-defined scale-up server from a plurality of computer platforms. In an example, the computer platforms include one or multiple rack-mounted servers. In another example, the plurality of computer platforms includes one or multiple enclosure-based servers. In another example, the computer platforms include one or multiple tower servers. In an example, the software-defined scale-up server includes a single virtual machine that runs across the physical compute nodes. In another example, the software-defined scale-up server includes multiple virtual machines, where each virtual machine runs across the physical compute nodes.

Each physical compute node includes a baseboard management controller. In an example, the baseboard management controller manages a host of its physical compute nodes. In an example, the baseboard management controller operates independently from an operating system of the host. In an example, the baseboard management controller monitors a state of the host. In an example, the baseboard management controller monitors the host for out-of-range telemetry values. In an example, the baseboard management controller detects software faults of the host. In an example, the baseboard management controller detects hardware faults of the host. In an example, the baseboard management controller manages virtual media associated with the host.

The technique 900 includes managing (block 908) the server. Pursuant to block 908, managing the server includes hosting a virtual machine on the baseboard management controllers. Hosting the virtual machine includes hosting, by the baseboard management controllers, a guest operating system that is distributed across the baseboard management controllers. In an example, the virtual machine corresponds to a virtual baseboard management controller. In an example, the virtual machine executes baseboard management controller applications. In an example, the virtual machine executes a firmware management stack. In an example, a distributed hypervisor provides and manages the virtual machine. In an example, the distributed hypervisor is distributed across the physical compute nodes. In an example, the distributed hypervisor includes hyper-kernels that are located on respective compute nodes of the server.

Pursuant to block 908, managing the server further includes using the virtual machine to manage physical host resources of the physical compute nodes. In an example, using the virtual machine to manage physical host resources includes monitoring the physical host resources. In an example, using the virtual machine to manage the physical host resources includes detecting hardware faults associated with the physical host resources. In another example, using the virtual machine to manage the physical host resources includes monitoring the physical host resources for out-of-range telemetry values. In another example, managing the physical host resources includes determining an inventory of the physical host resources. In another example, using the virtual machine to manage the physical host resources includes managing virtual media associated with the physical host resources.

In accordance with example implementations, the server is a modular server, and the physical compute nodes correspond to rack-mounted chassis units of the modular server. Among the potential benefits, physical management resources of multiple physical compute nodes are pooled together to support management application execution, and monolithic applications that are designed to be executed by a single physical management processor may be executed in the virtual environment.

In accordance with example implementations, the physical management processor includes a baseboard management controller. Among the potential benefits, physical management resources of multiple physical compute nodes are pooled together to support management application execution, and monolithic applications that are designed to be executed by a single physical management processor may be executed in the virtual environment.

In accordance with example implementations, each physical compute node includes an associated baseboard management controller. The virtual processors further execute the applications to communicate with the baseboard management controllers and manage the server based on the communication. Among the potential benefits, physical management resources of multiple physical compute nodes are pooled together to support management application execution, and monolithic applications that are designed to be executed by a single physical management processor may be executed in the virtual environment.

In accordance with example implementations, the virtual processors to execute a given application of the applications to receive telemetry data from the baseboard management controllers. The telemetry data represents information about the hosts. The virtual processors execute the given application to process the telemetry data to detect faults of the server. Among the potential benefits, physical management resources of multiple physical compute nodes are pooled together to support management application execution, and monolithic applications that are designed to be executed by a single physical management processor may be executed in the virtual environment.

In accordance with example implementations, the virtual processors to execute a given application of the applications to receive, from each baseboard management controller, host inventory data that represents an inventory of components of the associated host. The virtual processors to further execute the given application to, responsive to the host inventory data received from the baseboard management controllers, provide, to an administrative node, an inventory of the server. Among the potential benefits, physical management resources of multiple physical compute nodes are pooled together to support management application execution, and monolithic applications that are designed to be executed by a single physical management processor may be executed in the virtual environment.

In accordance with example implementations, the virtual processors to execute a given application of the applications to designate a virtual media boot device for the server. Among the potential benefits, physical management resources of multiple physical compute nodes are pooled together to support management application execution, and monolithic applications that are designed to be executed by a single physical management processor may be executed in the virtual environment.

In accordance with example implementations, the virtual processors to execute a given application of the applications to receive, from each baseboard management controller, event data representing events for the associated host. The virtual processors to execute the given application to, responsive to the event data received from the baseboard management controllers, update an event log for the server. Among the potential benefits, physical management resources of multiple physical compute nodes are pooled together to support management application execution, and monolithic applications that are designed to be executed by a single physical management processor may be executed in the virtual environment.

In accordance with example implementations, the virtual processors to execute a given application of the applications to schedule a firmware update for a given baseboard management controller of the baseboard management controllers. Among the potential benefits, physical management resources of multiple physical compute nodes are pooled together to support management application execution, and monolithic applications that are designed to be executed by a single physical management processor may be executed in the virtual environment.

In accordance with example implementations, a first physical compute node hosts a given virtual processor. The distributed hypervisor to further migrate the given virtual processor to a second physical compute node such that the second physical node hosts the given virtual processor. The distributed hypervisor to further remove the first physical compute node from the plurality of physical compute nodes such that after the removal, the distributed hypervisor is not hosted on the first physical compute node. Among the potential benefits, physical management resources of multiple physical compute nodes are pooled together to support management application execution, and monolithic applications that are designed to be executed by a single physical management processor may be executed in the virtual environment.

In accordance with example implementations, the distributed hypervisor further, responsive to a request to add an additional physical compute node to the plurality of physical compute nodes, adds the additional physical compute node to the plurality of physical compute nodes, and deploys an additional hyper-kernel to the additional physical compute node such that the additional hyper-kernel is part of the distributed hypervisor. Among the potential benefits, physical management resources of multiple physical compute nodes are pooled together to support management application execution, and monolithic applications that are designed to be executed by a single physical management processor may be executed in the virtual environment.

The detailed description set forth herein refers to the accompanying drawings. Wherever possible, the same reference numbers are used in the drawings and the foregoing description to refer to the same or similar parts. It is to be expressly understood, however, that the drawings are for the purpose of illustration and description only. While several examples are described in this document, modifications, adaptations, and other implementations are possible. Accordingly, the detailed description does not limit the disclosed examples. Instead, the proper scope of the disclosed examples may be defined by the appended claims.

The terminology used herein is for the purpose of describing particular examples only and is not intended to be limiting. As used herein, the singular forms "a," "an," and "the" are intended to include the plural forms as well, unless the context clearly indicates otherwise. The term "plurality," as used herein, is defined as two or more than two. The term "another," as used herein, is defined as at least a second or more. The term "connected," as used herein, is defined as connected, whether directly without any intervening elements or indirectly with at least one intervening elements, unless otherwise indicated. Two elements can be coupled mechanically, electrically, or communicatively linked through a communication channel, pathway, network, or system. The term "and/or" as used herein refers to and encompasses any and all possible combinations of the associated listed items. It will also be understood that, although the terms first, second, third, etc. may be used herein to describe various elements, these elements should not be limited by these terms, as these terms are only used to distinguish one element from another unless stated otherwise or the context indicates otherwise. As used herein, the term "includes" means includes but not limited to, the term "including" means including but not limited to. The term "based on" means based at least in part on.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A server comprising:
a plurality of physical compute nodes, wherein each physical compute node of the plurality of physical compute nodes comprises a host and physical management resources separate from the host, and wherein the physical management resources of each physical compute node of the plurality of physical compute nodes comprise a physical management processor; and
a distributed hypervisor to provide a distributed application operating environment hosted by the physical management resources, wherein the distributed hypervisor to allocate, from the physical management processors, virtual processors for the distributed application operating environment to execute applications to manage the plurality of physical compute nodes, wherein the distributed hypervisor comprises a plurality of hyper-kernels associated with respective physical compute nodes of the plurality of physical compute nodes, and wherein each hyper-kernel of the plurality of hyper-kernels is hosted on the physical management resources of the associated physical compute node.

2. The server of claim 1, wherein:
the server comprises a modular server; and
the physical compute nodes comprise rack-mounted chassis units.

3. The server of claim 1, wherein the physical management processor comprises a baseboard management controller.

4. The server of claim 1, wherein:
each physical compute node of the plurality of physical compute nodes comprises an associated baseboard management controller; and
the virtual processors to further execute the applications to communicate with the baseboard management controllers and manage the server based on the communication.

5. The server of claim 1, wherein the virtual processors to execute a given application of the applications to:
receive telemetry data from the baseboard management controllers, wherein the telemetry data represents information about the hosts; and
process the telemetry data to detect faults of the server.

6. The server of claim 1, wherein the virtual processors to execute a given application of the applications to:
receive, from each baseboard management controller of the baseboard management controllers, host inventory data representing an inventory of components of the associated host; and
responsive to the host inventory data received from the baseboard management controllers, provide, to an administrative node, an inventory of the server.

7. The server of claim 1, wherein the virtual processors to execute a given application of the applications to designate a virtual media boot device for the server.

8. The server of claim 1, wherein the virtual processors to execute a given application of the applications to:
receive, from each baseboard management controller of the baseboard management controllers, event data representing events for the associated host; and
responsive to the event data received from the baseboard management controllers, update an event log for the server.

9. The server of claim 1, wherein the virtual processors to execute a given application of the applications to schedule a firmware update for a given baseboard management controller of the baseboard management controllers.

10. The server of claim 1, wherein:
a first physical compute node of the plurality of physical compute nodes hosts a given virtual processor of the virtual processors; and
the distributed hypervisor to further:
migrate the given virtual processor to a second physical compute node of the plurality of physical compute nodes such that the second physical compute node hosts the given virtual processor; and
remove the first physical compute node from the plurality of physical compute nodes such that after the removal, the distributed hypervisor is not hosted on the first physical compute node.

11. The server of claim 1, wherein the distributed hypervisor to further, responsive to a request to add an additional physical compute node to the plurality of physical compute nodes:
add the additional physical compute node to the plurality of physical compute nodes; and
deploy an additional hyper-kernel to the additional physical compute node such that the additional hyper-kernel is part of the distributed hypervisor.

12. A system comprising:
a plurality of computer platforms, wherein each computer platform of the plurality of physical computer platforms comprises a host, a baseboard management controller and a physical rack management processor; and
a hypervisor distributed across the plurality of computer platforms to provide a virtual rack management controller to manage the baseboard management controllers, wherein the hypervisor to allocate, from the physical rack management processors, virtual processors for the virtual rack management controller, and wherein the hypervisor comprises a plurality of hyper-kernels hosted on respective computer platforms of the plurality of computer platforms.

13. The system of claim 12, wherein:
a given computer platform of the computer platforms comprises a physical memory; and
the distributed hypervisor to allocate, from the physical memory, a virtual memory for the virtual rack management controller.

14. The system of claim 12, wherein:
the virtual rack management controller to execute an application to manage the baseboard management controller; and
the application is executable by physical rack management processor of the physical rack management processors without modification.

15. The system of claim 12, wherein the distributed hypervisor to provide a guest operating system distributed across the plurality of computer platforms.

16. A method comprising:
aggregating a plurality of physical compute nodes to provide a server, wherein each physical compute node of the plurality of physical compute nodes comprises a baseboard management controller; and
managing the server, wherein managing the server comprises:
hosting a virtual machine on the baseboard management controllers, wherein hosting the virtual machine comprises hosting, by the baseboard management controllers, a guest operating system distributed across the baseboard management controllers; and
using the virtual machine to manage physical host resources of the plurality of physical compute nodes.

17. The method of claim 16, wherein hosting the virtual machine further comprises hosting, by the baseboard management controllers, respective hyper-kernels of a distributed hypervisor.

18. The method of claim 16, wherein hosting the virtual machine comprises allocating, by a distributed hypervisor and from physical processing cores of the baseboard management controllers, virtual processors for the virtual machine.

19. The method of claim 18, wherein using the virtual machine to manage the physical host resource comprises executing, by the virtual processors, instructions associated with a firmware management stack to manage the physical host resources.

20. The method of claim 16, wherein using the virtual machine to manage the physical host resources comprises at least one of controlling a system power state of a host of a physical compute node of the plurality of physical compute nodes, controlling a boot path of the host, performing thermal management of the host, managing the use of virtual media by the host, controlling a boot of the host, performing a security check for the host, performing a fault check for the host, validating firmware associated with the host, performing fault recovery of the host, or providing a remote console for a remote management server to manage the host.
